(19) United States
(12) Patent Application Publication
(10) Pub. No.: US 2026/0035075 A1
(43) Pub. Date: Feb. 5, 2026

(54) LAVATORY FOR USE BY PERSONS WITH REDUCED MOBILITY

(71) Applicant: Airbus Operations GmbH, HAMBURG (DE)

(72) Inventors: Gregor BEHLAU, HAMBURG (DE); Tjark MILES, HAMBURG (DE)

(21) Appl. No.: 19/285,418

(22) Filed: Jul. 30, 2025

(30) Foreign Application Priority Data
Aug. 1, 2024 (DE) 10 2024 121 969.6

(51) Int. Cl. B64D 11/00; B64D 11/02

(52) U.S. Cl. CPC B64D 11/0023; B64D 11/02

(57) ABSTRACT

A lavatory with a divider wall for a lavatory arrangement in an aircraft cabin. The divider wall has a primary wall section and a secondary wall section. Both wall sections are movably mounted such to be arranged in a closed state and in an opened state, wherein in the closed state, a separation of two adjacent lavatory spaces is provided, and in the opened state, the separation is cancelled, and the two adjacent lavatory spaces form a common enlarged lavatory space. The primary wall section has a primary wall panel movable between a separating position and a non-obstructing stored position. The secondary wall section has a secondary wall panel that with a first secondary panel segment movable between a vertical separating position and a horizontal position, in which it can be temporarily fixed to act as a seating transfer portion for a user of the common lavatory space.

### CROSS-REFERENCES TO RELATED APPLICATIONS

This application claims the benefit of German Patent Application Number 10 2024 121 969.6 filed on Aug. 1, 2024, the entire disclosure of which is incorporated herein by way of reference.

### FIELD OF THE INVENTION

The present invention relates to a lavatory that can be used by a person with reduced mobility. The present invention relates in particular to a divider wall for a lavatory arrangement in an aircraft cabin, to a lavatory arrangement for an aircraft cabin, to an aircraft, and to a method for transforming two lavatories into an enlarged common lavatory.

### BACKGROUND OF THE INVENTION

Lavatories are commonly provided on board of aircrafts for use by passengers during flight. In order to use as much space as possible for passenger seats, lavatories should be as small as possible. However, small lavatories providing minimized space may not allow to be used by persons with reduced mobility (PRM), like persons sitting in a wheelchair. As an example, WO 2011/101385 A2 provides a lavatory arrangement with two adjacent lavatories and a common movable partition wall that can be folded away to provide an enlarged lavatory space for use by persons having limited mobility. However, among aircraft operators, an interest exists in offering flight service for persons with reduced mobility with an increasing level of comfort.

### SUMMARY OF THE INVENTION

There may thus be a need to provide lavatories with a facilitated use for persons with reduced mobility.

An object of the present invention is solved by the subject-matter of one or more embodiments described herein, including, for example, embodiments for a divider wall for a lavatory arrangement in an aircraft cabin, for the lavatory arrangement for an aircraft cabin, for the aircraft and for the method for transforming two lavatories into an enlarged common lavatory.

According to the present invention, a divider wall for a lavatory arrangement in an aircraft cabin is provided. The divider wall comprises a primary wall section and a secondary wall section. The primary wall section and the secondary wall section are both configured to be movably mounted such to be arranged in a closed state and in an opened state; in the closed state, a separation of two adjacent lavatory spaces is provided, and in the opened state, the separation is cancelled, and the two adjacent lavatory spaces form a common enlarged lavatory space. The primary wall section comprises at least one primary wall panel that is movable between a separating position and a non-obstructing stored position. The secondary wall section comprises at least one secondary wall panel that comprises a first secondary panel segment that is movable between a vertical separating position and a horizontal position, in which it can be temporarily fixed to act as a seating transfer portion for a user of the common lavatory space.

As an effect, a transfer from a wheelchair to the toilet is facilitated and less complex. Due to offering an increased seating surface by the wall segment acting as a transfer portion, a person with reduced mobility can transfer from a wheelchair to the transfer surface, and from there onto the toilet. The angular movement for each transfer motion part is thus reduced as compared to a direct transfer from a wheelchair to a toilet seat. The increased lavatory space by combining both lavatories offers sufficient space for at least a wheelchair, thus increasing comfort when using the lavatory.

According to an example, the first secondary panel segment is configured to be pivotably mounted such that it can be pivoted from a vertical position into a horizontal position, in which it extends across a toilet of one of the two lavatory spaces, while the toilet of the other one of the two lavatory spaces remains usable.

As an advantage, the operation of the wall is easy and reliable, and the transformation can be arranged in a quick timely manner.

According to an example, the first secondary panel segment is configured to be pivotable around a pivot axis arranged as a swing axis such that an upper part of the first secondary panel pivots downwards on one side and a lower part of the first secondary panel pivots upwards on the other side. The part that pivots downwards acts as a main transfer portion and the part that pivots upwards acts as a bridging transfer portion to facilitate a seating transfer motion form the main transfer portion to the usable toilet.

As a result, a wheelchair can be moved close to the main transfer portion to ensure that only a minimum gap has to be crossed when moving, i.e., transferring between the wheelchair and the main transfer portion. Further, the bridging portion provides a minimized distance to be crossed when moving, i.e., transferring between the main transfer portion and the toilet seat.

According to an example, the secondary wall section comprises a second secondary panel segment that extends above the first secondary panel in the vertical separating position, which second secondary panel segment is movable between a separating position and a non-obstructing stored position.

The second secondary portion can be used for increased stability when being folded below the main transfer portion, or as support for the main transfer portion or for correctly levelling the main transfer portion.

As an option, the secondary wall section comprises a third secondary panel segment that extends below the first secondary panel.

The third secondary portion can be used to provide a fixed support structure for the first secondary portion, or can also be provided as movable, e.g. for cleaning and maintenance procedures.

As another option, in addition or alternatively, the third secondary panel segment is provided as a fixed wall segment acting as a vertical load carrying support for the first secondary panel segment when in the horizontal position.

As an advantage, a stable support can be provided in a non-complex manner allowing a direct load transfer.

According to an example, the second secondary panel segment can be folded downwards to be arranged below the first secondary panel segment in the horizontal position.

As an advantage, the transfer seat portion can be optimized in size to also leave free space next to the second toilet onto which the panel folds, for example as space for an assisting person.

According to an example, the second secondary panel segment can be folded downwards to act as a vertical stand for the first secondary panel segment in the horizontal position.

As an advantage, the transfer seat can be arranged in a height that is less dependent from the toilet below. Further, the load acting on the toilet seat below can be reduced or can be even completely avoided. As a further effect, the transfer portion is stabilized in addition to resting on the toilet seat beneath the transfer portion.

According to an example, the primary wall section comprises two primary wall panels that are configured as a bifolding wall section.

As an advantage, the separation wall can be removed in a space saving way.

According to an example, at least the primary wall panel is provided with an antibacterial surface.

As a result, cleaning and maintaining hygiene standards is facilitated.

The divider wall can be used for newly installed lavatories, i.e., lavatories that are mounted in a cabin space, but can also be applied for retrofit programs, e.g., when only a fixed common wall between two lavatories is replaced. The term “newly installed lavatories” relates to mounting lavatories in a cabin, such as when an aircraft is manufactured or when a cabin is remodeled, i.e., for retrofitting the complete lavatories.

According to the present invention, a lavatory arrangement for an aircraft cabin is provided. The lavatory arrangement comprises a first lavatory comprising a first lavatory housing enclosing a first lavatory space, and a second lavatory comprising a second lavatory housing enclosing a second lavatory space. The first lavatory and the second lavatory are arranged adjacent to each other. The first lavatory housing and the second lavatory housing share a common wall. The common wall is provided as a divider wall according to one of the preceding examples.

As an advantage, a lavatory solution is provided that allows a facilitated use for persons with reduced mobility, since the two spaces can be combined by removing a part of the divider wall and since the transfer from a wheelchair is facilitated.

According to an example, the first lavatory housing is provided with a first lavatory door movably closing a first door opening, and the second lavatory housing is provided with a second lavatory door movably closing a second door opening. In the separating position and in the non-obstructing stored position of the primary wall section, both the first and the second lavatory door openings are accessible and remain unaffected by the primary wall section of the divider wall.

As an effect, by maintain both doors as fully functional, options for support for an assist person are increased.

According to an example, in the main transfer portion, the first secondary panel segment is supported on its distal end by at least one of the group of:
i) resting on the non-used toilet;
ii) being supported by a cabin sidewall; and
iii) resting on a lavatory floor.

According to the present invention, also an aircraft is provided. The aircraft comprises a cabin space within a fuselage and at least one lavatory arranged within the cabin space. The at least one lavatory is provided as a lavatory arrangement according to one of the preceding examples.

According to the present invention, also a method for transforming two lavatories into an enlarged common lavatory is provided. The method comprises the following steps:
Moving a primary wall section of a divider wall from a closed state, in which a separation of two adjacent lavatory spaces is provided, into an opened state, in which the separation is cancelled and the two adjacent lavatory spaces form a common enlarged lavatory space; the primary wall section comprising at least one primary wall panel that is movable between a separating position and a non-obstructing stored position.
Moving a secondary wall section of the divider wall from a closed state, in which the separation of the two adjacent lavatory spaces is provided, into an opened state, in which the separation is cancelled, and the two adjacent lavatory spaces form the common enlarged lavatory space; the secondary wall section comprises at least one secondary wall panel that comprises a first secondary panel segment.

The moving of the secondary wall section comprises moving the first secondary panel segment from a vertical separating position into a horizontal position, in which it can be temporarily fixed, and, in the horizontal position, the first secondary panel segment is acting as a seating transfer portion for a user of the common lavatory space.

According to an aspect, a wall between two adjacent lavatories is moveable in several segments. A vertical part is moved aside, such as folded, to provide an open section combining the two lavatories in order to form an enlarged lavatory space which allows access by a wheelchair. The opening enables wheelchair movement between the two lavatories. Another part is folded downwards to provide a transfer seat which facilitates to move from a position sitting in the wheelchair to a position enabling the use of the toilet in the lavatory, and vice versa. Thus, a bi-functional divider wall is provided that enables to transform a dual lavatory arrangement into an enlarged lavatory for use by PRMs.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 schematically shows an example of a divider wall for a lavatory arrangement in an aircraft cabin in a plan view. The divider wall is shown in the context of an example of a lavatory arrangement for an aircraft cabin

FIG. 2 shows the divider wall and the lavatory arrangement of FIG. 1 in a side view along A-A in FIG. 1.

FIG. 3a shows a first step of a transforming sequence of the divider wall of FIG. 1 in a plan view.

FIG. 3b shows a second step of a transforming sequence of the divider wall of FIG. 1 in a plan view.

FIG. 3c shows a third step of a transforming sequence of the divider wall of FIG. 1 in a plan view.

FIG. 4 shows a top view of the lavatory arrangement providing an enlarged common lavatory space for the use by a person in a wheelchair, before transferring to the seating transfer portion provided by the transformed divider wall.

FIG. 5a shows a first step of a sequence of the transforming of the divider wall of FIG. 1 in a perspective view.

FIG. 5b shows a second step of a sequence of the transforming of the divider wall of FIG. 1 in a perspective view.

FIG. 5c shows a third step of a sequence of the transforming of the divider wall of FIG. 1 in a perspective view.

FIG. 5d shows a fourth step of a sequence of the transforming of the divider wall of FIG. 1 in a perspective view.

FIG. 6 shows a cross section of an example of an aircraft with a lavatory arrangement provided in a cabin space.

FIG. 7 shows basic steps of an example of a method for transforming two lavatories into an enlarged common lavatory.

### DETAILED DESCRIPTION OF THE PREFERRED EMBODIMENTS

Certain embodiments will now be described in greater details with reference to the accompanying drawings. In the following description, like drawing reference numerals are used for like elements, even in different drawings. The matters defined in the description, such as detailed construction and elements, are provided to assist in a comprehensive understanding of the exemplary embodiments. Also, well-known functions or constructions are not described in detail since they would obscure the embodiments with unnecessary detail. Moreover, expressions such as “at least one of”, when preceding a list of elements, modify the entire list of elements and do not modify the individual elements of the list.

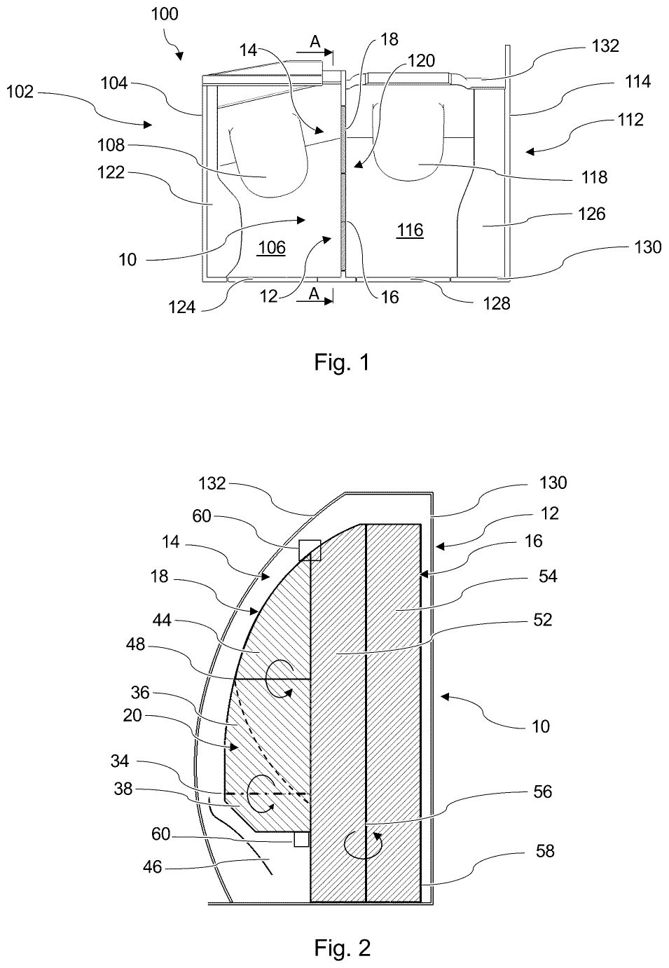

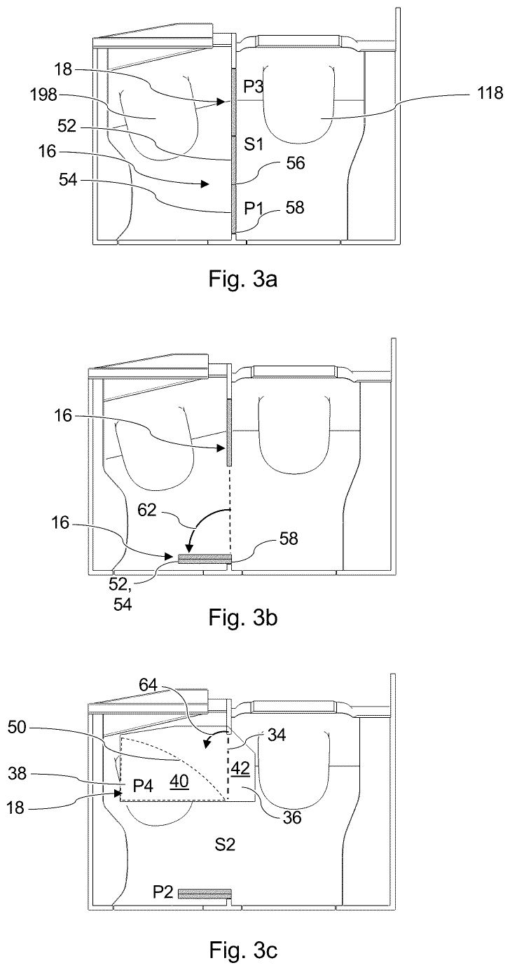

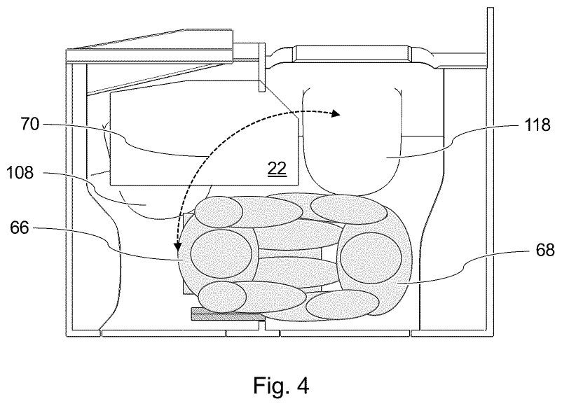

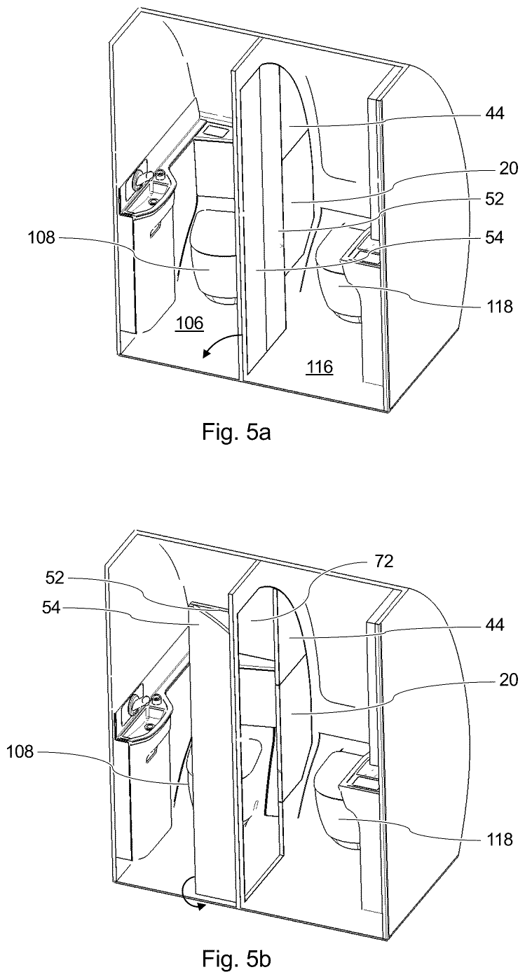

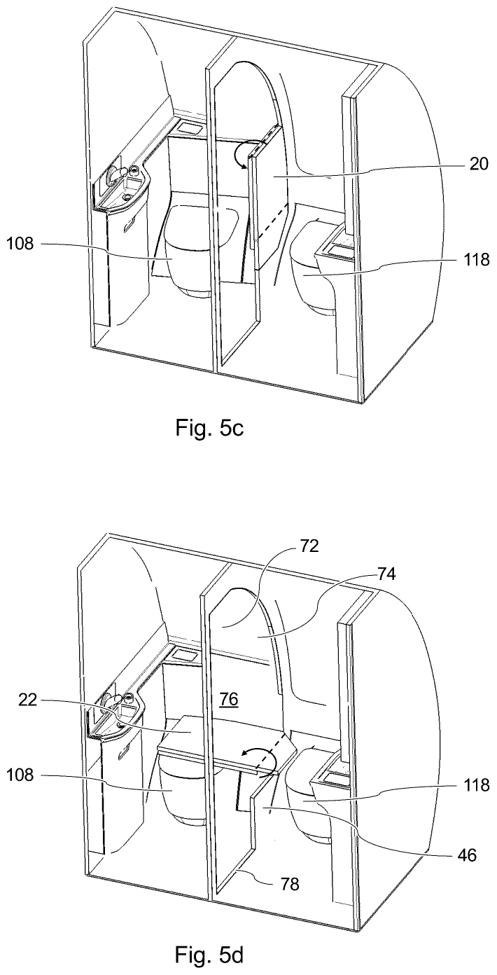

FIG. 1 schematically shows an example of a divider wall 10 for a lavatory arrangement in an aircraft cabin in a plan view. The divider wall 10 is shown in the context of an example of a lavatory arrangement for an aircraft cabin, which lavatory arrangement is shown as an option. The divider wall 10 comprises a primary wall section 12 and a secondary wall section 14. The primary wall section 12 and the secondary wall section 14 are both configured to be movably mounted such to be arranged in a closed state S1 (also see FIG. 3a and FIG. 5a) and in an opened state S2 (see FIG. 3c and FIG. 5d); in the closed state S1, a separation of two adjacent lavatory spaces is provided, and in the opened state S2, the separation is cancelled and the two adjacent lavatory spaces form a common enlarged lavatory space (also see FIG. 3c and FIG. 5d). The primary wall section 12 comprises at least one primary wall panel 16 that is movable between a separating position P1 and a non-obstructing stored position P2. The secondary wall section 14 comprises at least one secondary wall panel 18 that comprises a first secondary panel segment 20 that is movable between a vertical separating position P3 and a horizontal position P4, in which it can be temporarily fixed to act as a seating transfer portion 22 (see FIG. 3c, FIG. 4 and FIG. 5d) for a user of the common lavatory space.

The term “divider wall” refers to a wall that divides two lavatory spaces from each other.

The term “wall section” refers to a part of the wall.

The term “movably mounted” refers to being mounted in a way that a temporal fixation is possible as well as a temporal relative movement. An example for being movably mounted is a pivoting mount via a hinge or the like. Another example for being movably mounted is a removable fixation.

The term “closed state” refers to closing off the two adjacent spaces from each other, at least in a functional way relating to the use of the lavatory. As an example, small gaps or slits can still be present, while the two spaces are closed off from each other. In the closed state, both rooms, such as lavatory spaces are separated and usable individually.

The term “opened state” refers to a state where the wall is at least partly removed, and the two spaces are connected in a functional way.

The term “separation” refers to both adjacent spaces being divided and usable individually.

The term “common enlarged lavatory space” refers to both spaces forming a single lavatory space which is larger than the respective lavatories themselves.

The term “separating position” refers to a position of the wall segments, in which the separation function is provided, like the closed state. In the separating position, the divider wall is in the way so-to-speak and thus obstructing in terms of moving from the one room to the other.

The term “non-obstructing stored position” refers to a position of the wall segments, in which the separation function is cancelled and no longer given, like the opened state. In the non-obstructing stored position, the divider wall is out of the way so-to-speak at least essentially and thus no longer obstructing in terms of moving from the one room to the other.

The seating transfer portion can also be referred to as seating transfer surface.

The primary wall section and the secondary wall section are both configured to be movably mounted such to be arranged in the closed state or the opened state. In an example, the primary wall section and the secondary wall section are both configured to be movable between the closed state and the opened state, i.e. from the closed state to the opened state and vice versa.

In an example, the primary wall section comprises at least one primary wall panel that comprises a first primary panel segment that is movable between a vertical separating position and a vertical non-obstructing stored or removed position, in which it can be temporarily fixed to a lavatory housing or other cabin structure.

The primary panel segment of the primary wall section is configured to be movably mounted such to be arranged in the vertical separating position or the vertical non-obstructing stored position.

The first secondary panel segment of the secondary wall section is configured to be movably mounted such to be arranged in the vertical separating position or the horizontal position.

The first secondary panel segment is provided as a dual-function segment. In a first function, the panel segment is forming a wall segment; and in a second function, the panel segment is forming a seating or resting segment.

In an example, the movable parts of the divider wall are connected via rabbet profile sections or angel profile sections.

As indicated above, as an option, FIG. 1 shows a lavatory arrangement 100 for an aircraft cabin. The lavatory arrangement 100 comprises a first lavatory 102 comprising a first lavatory housing 104 enclosing a first lavatory space 106, and a second lavatory 112 comprising a second lavatory housing 114 enclosing a second lavatory space 116. The first lavatory 102 and the second lavatory 112 are arranged adjacent to each other. The first lavatory housing 104 and the second lavatory housing 114 share a common wall 120. The common wall 120 is provided as an example of the divider wall 10 according to one of the preceding and following examples.

The term “lavatory arrangement” refers to a part inside an aircraft cabin that provides e.g., two or more lavatories, i.e., spaces in which a sanitary function is provided, such as a sink, a toilet and a urinal. The lavatory arrangement 100 can also be referred to as a lavatory monument or lavatory partition.

The term “lavatory” refers to space enclosed that provides such sanitary function. The lavatory can also be referred to as restroom or toilet.

The term “lavatory housing” refers to the physical structure enclosing or encapsulating space to provide the respective sanitary function. The lavatory housing accommodates the space. The enclosing can have slits or smaller gaps, but generally provides a separation from its environment and surroundings. The lavatory housing can also be referred to as restroom housing or toilet housing, or enclosure. A part of an inner lining of a fuselage can also be part of the housing.

The term “lavatory space” refers to the actual space provided for the sanitary function. The lavatory space can also be referred to as lavatory. The lavatory space can also be referred to as restroom space or toilet space.

The term “common wall” refers to a wall shared by both adjacent parties.

In an example, the first lavatory space 106 comprises a first toilet 108 and the second lavatory space 116 comprises a second toilet 118.

Due to the enlarged common lavatory space, a person with reduced mobility can rest on the seating transfer portion, which is arranged above one of the toilets, and then transfer to the toilet seat of the other one of the toilets. In an option, the transfer is possible by the user him- or herself. In another option, the transfer is possible by the support of a support person who can also be in the common lavatory space.

In an example, the two adjacent lavatories have toilets that are arranged parallel to each other.

In another example, as shown in FIG. 1, one of the two adjacent lavatories has a toilet that is arranged inclined to an orientation of the toilet of the other one of the two adjacent lavatories. In other words, both axes of orientation intersect. For example, at least one of the two toilets faces towards the other toilet in an inclined manner. The axis of orientation can be defined as a center line of the toilet from its mounting rear side towards the toilet space. The axis of orientation cab thus be the same as a main viewing direction of a user using the toilet in a western-oriented sitting manner.

In FIG. 1, the first lavatory space 106 comprises a first wash basin 122, provided (in the drawing) on the lefthand side within the first lavatory space 106. Further, the first lavatory housing 104 is provided with a first lavatory door 124 movably closing a first door opening.

In FIG. 1, the second lavatory space 116 comprises a second wash basin 126, provided (in the drawing) on the righthand side within the second lavatory space 116. Further, the second lavatory housing 114 is provided with a second lavatory door 128 movably closing a second door opening.

It is noted that the terms first, second, etc. do not mean any priority or sequence in use or any other restriction.

According to an option, in the separating position and in the non-obstructing stored position of the primary wall section, both the first and the second lavatory door openings are accessible and remain unaffected by the primary wall section of the divider wall.

This allows an access to the common lavatory space e.g., by a user with reduced mobility by one door, and access to the common lavatory space by a support person in order to provide support to the user with reduced mobility by the other door.

In an example, the primary wall section folds against a frame section. In an option, the primary wall section only partly overlaps with the respective door opening of the toilet space in which the toilet is covered by the pivoted first secondary panel segment.

The first lavatory door 124 and the second lavatory door 128 can be arranged within a common front, or aisle-facing surface panel 130 that extends across the first lavatory space 106 and the second lavatory space 116. However, also two separate aisle-facing surface panels can be provided.

In FIG. 1, a rear side 132 of the lavatory arrangement is indicated as following a contour of a fuselage structure (not shown). The rear side 132 can be a separate common panel of the housing, i.e. a common rearwards facing surface panel of the first lavatory housing 104 and the second lavatory housing 114. However, also two separate rear-facing surface panels can be provided. In another option, the rear inner wall segment enclosing the two lavatory spaces is provided by an inner lining or cabin panel or segments thereof mounted to the fuselage.

However, also two separate rear-facing surface panels can be provided.

As an option, the first secondary panel segment 20 is configured to be pivotably mounted such that it can be pivoted from a vertical position into a horizontal position, in which it extends across a toilet of one of the two lavatory spaces, while the toilet of the other one of the two lavatory spaces remains usable.

The term “pivotably mounted” refers to a mount via a hinge, allowing a rotational movement around an axis. The term “pivotably mounted” also refers to a mount allowing a combination of a rotating and sliding movement.

As an option, the first secondary panel segment 20 is configured to be pivotable around a pivot axis 34 arranged as a swing axis such that an upper part 36 of the first secondary panel segment 20 pivots downwards on one side and a lower part 38 of the first secondary panel segment 20 pivots upwards on the other side; wherein the part that pivots downwards acts as a main transfer portion 40 and the part that pivots upwards acts as a bridging transfer portion 42 to facilitate a seating transfer motion form the main transfer portion to the usable toilet.

The term “main transfer portion” refers to a portion of the wall surface when in horizontal orientation that acts as a seat or resting surface for transferring a person onto a toilet. For example, a transfer from the main transfer portion onto the toilet seat is provided and vice versa. For example, a transfer from a wheelchair, e.g. an onboard wheelchair, onto the main transfer portion and from there onto the toilet seat is provided and vice versa.

The term “bridging transfer portion” refers to a portion of the wall surface when in horizontal orientation that acts as a bridge at least partly closing a gap that would otherwise exist.

The bridging transfer portion is configured to close a part of a gap towards the toilet being used.

In an example, the distal contour of the bridging transfer portion is adapted to be following the contour of the usable toilet, e.g., leaving a continuous gap allowing a gripping action by the user.

As an option, the first secondary panel segment can be temporarily fixed in the horizontal position.

The term “temporarily fixed” refers to locking the panel such that it does not move, i.e. that it remains its position in a stable manner. The locking can be released, of course.

The term “horizontal position” refers to an orientation of the panel that is suitable for sitting on the panel. This can be exactly horizontal, or relative horizontal in relation to a surrounding cabin during use, such as parallel to the floor, or can deviate by e.g., up to +/−5 degrees, +/−10 degrees, +/−15 degrees, +/−20 degrees, or even +/−25 degrees.

In an example, an adjustment device is provided to arrange the seating surface in an approximately absolute horizontal arrangement, independent of the actual inclination of a cabin. For example, the adjustment device compensates for an inclined situation of the aircraft cabin, such as during travel flight phases.

The adjustment device enables to arrange the transfer surface horizontally in the direction of the aircraft in relation to gravity, or deliberately at an angle, so that the transfer is either balanced in both directions or easier in one direction, i.e., from the transfer surface to the toilet seat or from the toilet seat to the transfer surface. In an option, the adjustment device provides adjustability.

In another example, a side-dependent, e.g., starboard side versus port side formation of the module is provided.

As an option, the secondary wall section 14 comprises a second secondary panel segment 44 that extends above the first secondary panel in the vertical separating position, which second secondary panel segment is movable between a separating position and a non-obstructing stored position. As an option, the secondary wall section 14 comprises a third secondary panel segment 46 that extends below the first secondary panel.

In an example, as shown, the second secondary panel segment 44 is connected to the first secondary panel segment 20 by a hinge providing a further pivot axis 48.

As an option, the third secondary panel segment 46 is provided as a fixed wall segment acting as a vertical load carrying support for the first secondary panel segment when in the horizontal position.

As an option, the second secondary panel segment can be folded downwards to be arranged below the first secondary panel segment in the horizontal position. This is indicated in FIG. 3c with a broken line 50.

As an option, the second secondary panel segment can be folded downwards to act as a vertical stand for the first secondary panel segment in the horizontal position.

The term “stand” refers to providing a load transfer by resting on the floor or other suitable structure, such as a lower part of a shroud of a toilet.

The second secondary panel segment can also be referred to as upper secondary panel segment.

The primary wall section can also be referred to as first wall section.

The secondary wall section can also be referred to as second wall section.

The closed state can also be referred to as first state.

The opened state can also be referred to as second state.

The term “separation” refers to a state, in which the two toilet spaces are separated from each other such that they can both be used individually.

The two lavatory spaces can also be referred to as two lavatories.

As an option, the primary wall section 12 comprises two primary wall panels 52, 54 that are configured as a bifolding wall section.

The term “bifolding” refers to e.g. a wall with two panel segments that are both pivotable along a vertical axis 56, such that the wall can be folded away. The term indicates the presence of two pivoting axes.

As an example, a further pivot axis 58 is provided near the front of the lavatory arrangement 100.

The two primary wall panels are configured as a vertical bifold wall section.

In an example, the secondary wall section comprises two secondary wall panels that are configured as a pivot wall section. The two secondary wall panels are configured as a horizontal bifold wall section.

In another example, the first secondary panel segment and the second secondary panel segment are configured as a bi-pivoting wall section. The two secondary panel segments are configured as a horizontal bifold wall section.

In an example, the primary wall section comprises three primary wall panels that are configured as a tri-folding wall section

In an option, the divider wall is provided as a retrofit kit to replace existing (common) separation walls between two adjacent lavatories.

In a further option, the primary wall section is provided to be pivoted into a non-obstructing position.

In a still further option, the primary wall section is provided to be moved into a non-obstructing position in a sliding manner.

As an option, at least the primary wall panel 16 is provided with an antibacterial surface.

In an example, the antibacterial surface is an enamel varnish, e.g. a foil. In an example, the antibacterial surface is a coating, e.g., a foil.

As a first option, in the main transfer portion, the first secondary panel 20 segment is supported on its distal end by resting on the non-used toilet.

As a second option, in the main transfer portion, the first secondary panel segment is supported on its distal end by being supported by a cabin sidewall.

As a third option, in the main transfer portion, the first secondary panel segment is supported on its distal end by resting on a lavatory floor.

The term “supported” refers to resting on, i.e., transferring load towards a structural part. The term “supported” refers to e.g., resting on the floor, or resting on an abutting protrusion in the side wall. The term “supported” also comprises to an engagement with a counter profile.

The term “distal end” refers to the part of the panel segment that is opposite to a pivoting support or the like.

As an option, a release mechanism 60 for holding the divider wall 10 in the closed and the opened state is provided. The release mechanism 60 and an adaptation of the divider wall 10 is operable by crew members.

In an option, the operation is enabled exclusively for the crew members.

The term “release mechanism” refers to a latch or the like that can be activated to release the divider wall in order to be able to move it.

FIG. 2 shows the divider wall and the lavatory arrangement of FIG. 1 in a side view along viewing line A-A in FIG. 1. The divider wall 10 is in its closed state S1.

FIG. 3a, FIG. 3b and FIG. 3c show a transforming sequence of the divider wall 10 of FIG. 1 in a plan view.

In FIG. 3a, both the primary wall section 12 and the secondary wall section 14 are arranged in the separating manner. Thus, two separate toilet spaces are provided that can be used individually.

In FIG. 3b, the two primary wall panels 52, 54 are folded towards the front panel, as indicated with a primary arrow 62.

In FIG. 3c, after the second secondary panel segment 44 had been folded downwards abutting the secondary wall panel 18, the secondary wall panel 18, together with the second secondary panel segment 44, is folded downwards as well, as indicated with a secondary arrow 64.

FIG. 4 shows a top view of the lavatory arrangement providing an enlarged common lavatory space for the use by a person 66 in a wheelchair, before transferring to the seating transfer portion 22 provided by the transformed divider wall 10. As an option, an assisting person 68 is indicated. Due to providing the seating transfer portion 22, the person 66 in the wheelchair can transfer to the second toilet 118, as indicated by transfer arrow 70 in a broken line.

FIG. 5a, FIG. 5b, FIG. 5c and FIG. 5d show a sequence of the transforming of the divider wall 10 of FIG. 1 in a perspective view. It is noted that the front doors are not shown.

In FIG. 5a, the divider wall 10 is closed and two separate toilet spaces are provided. An arrow indicates the start of the folding motion of the primary wall section 12.

In FIG. 5b, the two panels of the primary wall section 12 are folded towards the inner side of the front panel, but an access for the assist person is still possible. A first opening portion 72 is shown.

In FIG. 5c, the upper panel, i.e. the second secondary panel segment 44, has been folded downwards, as indicated with an arrow.

In FIG. 5d, the first secondary panel segment 20 has been folded downwards onto the first toilet 108 with one part, as indicated with an arrow, and the other part has been folded upwards, partly closing the gap to the second toilet 118. The seating transfer portion 22 is provided. The first opening portion 72 and the second opening portion 74 provide an opening 76. It is noted that in FIG. 5d, a lower double line 78b indicates a portion within the floor plane that is configured for an abutting sealing of the bifold wall parts when in closed state. The lower contour is e.g., even with adjacent floor sections, as to ensure a smooth and continuous surface level suitable for wheelchair movement in this part of the enlarged lavatory.

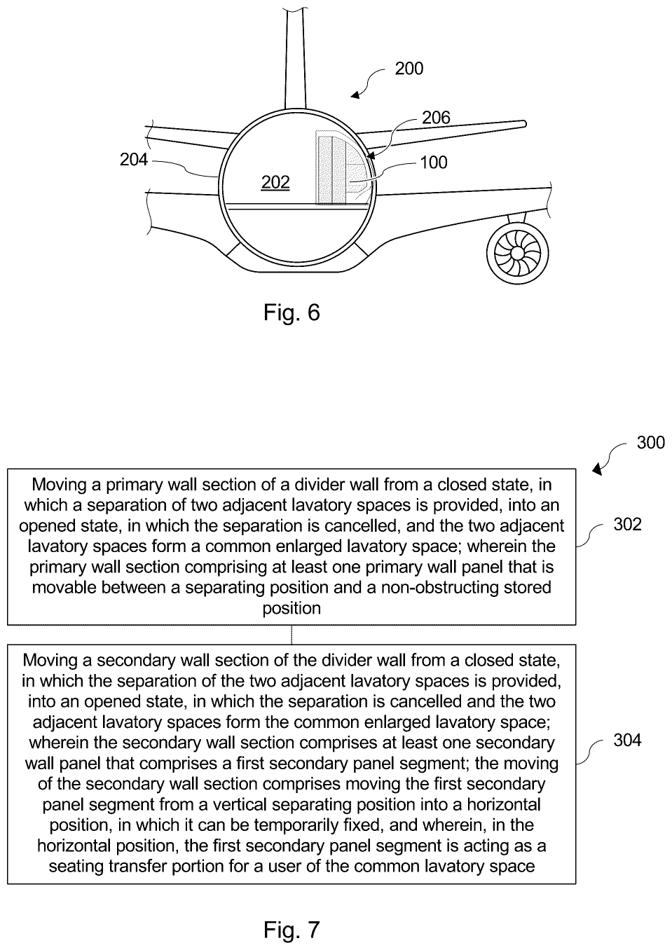

FIG. 6 shows a cross section of an example of an aircraft 200 comprising a cabin space 202 within a fuselage 204. The aircraft 200 also comprises at least one lavatory 206 arranged within the cabin space. At least one lavatory is provided as an example of the lavatory arrangement 100 according to one of the examples above.

FIG. 7 shows basic steps of an example of a method 300 for transforming two lavatories into an enlarged common lavatory. The method comprises the following steps:
In a first step 302, a primary wall section of a divider wall is moved from a closed state, in which a separation of two adjacent lavatory spaces is provided, into an opened state, in which the separation is cancelled, and the two adjacent lavatory spaces form a common enlarged lavatory space. The primary wall section comprising at least one primary wall panel that is movable between a separating position and a non-obstructing stored position.
In a second step 304, a secondary wall section of the divider wall is moved from a closed state, in which the separation of the two adjacent lavatory spaces is provided, into an opened state, in which the separation is cancelled, and the two adjacent lavatory spaces form the common enlarged lavatory space. The secondary wall section comprises at least one secondary wall panel that comprises a first secondary panel segment. The moving of the secondary wall section comprises moving the first secondary panel segment from a vertical separating position into a horizontal position, in which it can be temporarily fixed, and wherein, in the horizontal position, the first secondary panel segment is acting as a seating transfer portion for a user of the common lavatory space.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A divider wall for a lavatory arrangement in an aircraft cabin, the divider wall comprising:
a primary wall section; and
a secondary wall section;
wherein the primary wall section and the secondary wall section are both configured to be movably mounted such to be arranged in a closed state and in an opened state, wherein in the closed state, a separation of two adjacent lavatory spaces is provided, and in the opened state, the separation is absent and the two adjacent lavatory spaces form a common enlarged lavatory space,
wherein the primary wall section comprises at least one primary wall panel movable between a separating position and a non-obstructing stored position, and
wherein the secondary wall section comprises at least one secondary wall panel that comprises a first secondary panel segment movable between a vertical separating position and a horizontal position, in which the first secondary panel segment is configured to be temporarily fixed to act as a seating transfer portion for a user of the common lavatory space.

2. The divider wall according to claim 1, wherein the first secondary panel segment is configured to be pivotably mounted to pivot from a vertical position into a horizontal position, in which the first secondary panel segment extends across a toilet of one of the two lavatory spaces, while the toilet of the other one of the two lavatory spaces remains usable.

3. The divider wall according to claim 1, wherein the first secondary panel segment is configured to be pivotable around a pivot axis arranged as a swing axis such that an upper part of the first secondary panel segment pivots downwards on one side and a lower part of the first secondary panel segment pivots upwards on a second side, and
wherein the upper part acts as a main transfer portion and the lower part acts as a bridging transfer portion to facilitate a seating transfer motion form the main transfer portion to the toilet.

4. The divider wall according to claim 1, wherein the first secondary panel segment is configured to be temporarily fixed in the horizontal position.

5. The divider wall according to claim 1, wherein the secondary wall section comprises a second secondary panel segment that extends above the first secondary panel segment in the vertical separating position, which second secondary panel segment is movable between a separating position and a non-obstructing stored position,
wherein the secondary wall section comprises a third secondary panel segment that extends below the first secondary panel, and
wherein the third secondary panel segment is provided as a fixed wall segment acting as a vertical load carrying support for the first secondary panel segment when in the horizontal position.

6. The divider wall according to claim 5, wherein the second secondary panel segment is configured to be folded downwards to be arranged below the first secondary panel segment in the horizontal position.

7. The divider wall according to claim 5, wherein the second secondary panel segment is configured to be folded downwards to act as a vertical stand for the first secondary panel segment in the horizontal position.

8. The divider wall according to claim 1, wherein the primary wall section comprises two primary wall panels that are configured as a bifolding wall section.

9. The divider wall according to claim 1, wherein at least the at least one primary wall panel is provided with an antibacterial surface.

10. A lavatory arrangement for an aircraft cabin, the lavatory arrangement comprising:
a first lavatory comprising a first lavatory housing enclosing a first lavatory space; and
a second lavatory comprising a second lavatory housing enclosing a second lavatory space,
wherein the first lavatory and the second lavatory are arranged adjacent to each other,
wherein the first lavatory housing and the second lavatory housing share a common wall, and
wherein the common wall comprises the divider wall according to claim 1.

11. The lavatory arrangement according to claim 10, wherein the first lavatory housing is provided with a first lavatory door movably closing a first door opening, and the second lavatory housing is provided with a second lavatory door movably closing a second door opening, and
wherein, in the separating position and in the non-obstructing stored position of the primary wall section, both the first lavatory door opening and the second lavatory door opening are accessible and remain unaffected by the primary wall section of the divider wall.

12. The lavatory arrangement according to claim 10, wherein, in the main transfer portion, the first secondary panel segment is supported on a distal end by at least one of the group of:
i) resting on an used toilet;
ii) being supported by a cabin sidewall; and
iii) resting on a lavatory floor.

13. The lavatory arrangement according to claim 10, wherein a release mechanism for holding the divider wall in the opened state is provided, and
wherein the release mechanism and an adaptation of the divider wall is operable by crew members.

14. An aircraft comprising:
a cabin space within a fuselage; and
at least one lavatory arranged within the cabin space,
wherein the at least one lavatory comprises the lavatory arrangement according to claim 10.

15. A method for transforming two lavatories into an enlarged common lavatory, the method comprising the following steps:
moving a primary wall section of a divider wall from a closed state, in which a separation of two adjacent lavatory spaces is provided, into an opened state, in which the separation is absent and the two adjacent lavatory spaces form a common enlarged lavatory space, wherein the primary wall section comprising at least one primary wall panel that is movable between a separating position and a non-obstructing stored position; and,
moving a secondary wall section of the divider wall from a closed state, in which the separation of the two adjacent lavatory spaces is provided, into an opened state, in which the separation is absent and the two adjacent lavatory spaces form the common enlarged lavatory space, wherein the secondary wall section comprises at least one secondary wall panel that comprises a first secondary panel segment,
wherein the moving of the secondary wall section comprises moving the first secondary panel segment from a vertical separating position into a horizontal position, in which the first secondary panel segment is temporarily fixed, and
wherein, in the horizontal position, the first secondary panel segment acts as a seating transfer portion for a user of the common lavatory space.
